(19) United States
(12) Patent Application Publication
(10) Pub. No.: US 2020/0114835 A1
(43) Pub. Date: Apr. 16, 2020

(54) DOCK AND METHOD OF SWITCHING BETWEEN ANTENNA SIGNAL

(71) Applicant: Getac Technology Corporation, Hsinchu County (TW)

(72) Inventors: Yi-Chia Chiu, Taipei (TW); His-Yang Yeh, Taipei (TW)

(21) Appl. No.: 16/158,692

(22) Filed: Oct. 12, 2018

(51) Int. Cl. B60R 11/02

(52) U.S. Cl. CPC B60R 11/0264; B60R 2011/0075; B60R 11/0258; B60R 11/0241

(57) ABSTRACT

A dock adapted to connect to a portable electronic device is provided. The portable electronic device has a first antenna signal transceiving mode and a second antenna signal transceiving mode. The portable electronic device switches from the first antenna signal transceiving mode to the second antenna signal transceiving mode when a magnetic sensor of the portable electronic device senses the presence of a magnetic force. The dock includes a base, back support element, limit component and magnetic component. The base has a connection surface which the limit component faces. Two ends of the back supporting element adjoin the base and the limit component, respectively. The magnetic component is disposed on the connection surface and generates the magnetic force. The portable electronic device is placed between the connection surface, back supporting element and limit component. Therefore, vibration accompanying vehicle movement and external mechanism-induced errors/failures of antenna signal switching are precluded.

### BACKGROUND OF THE INVENTION

### Field of the Invention

The present disclosure relates to a dock and a method of switching between antenna signals.

### Description of the Prior Art

Every conventional portable electronic device, for example, a tablet, a mobile phone and a navigator, has a connection interface in order to fulfill the purpose of and meet the demand for transmission of power, data and antenna signals. A user connects a corresponding transmission cable or a dock to the connection interface, so as to transmit power, data and antenna signals to the portable electronic device.

To enhance ease of use of portable electronic devices, the prior art provides indoor (for example, workplace-oriented) docks and vehicular docks for use with portable electronic devices. The vehicular docks are connected to vehicular antennas. When disposed on the indoor dock, the portable electronic device transmits and receives signals with its own antenna. When disposed on the vehicular dock, the portable electronic device transmits and receives signals with the vehicular antenna through the vehicular dock.

The vehicular dock and the portable electronic device are connected by an external mechanism, for example, a spring connector. The portable electronic device transmits and receives signals with the vehicular antenna through the vehicular dock as soon as male and female terminals of the spring connector are touched and pressed. If the male and female terminals of the spring connector are touched but not sufficiently pressed or are shifted because of vibration accompanying vehicle movement, the portable electronic device will fail to switch from an antenna signal transceiving mode to a vehicular antenna signal transceiving mode; as a result, antenna signals cannot be transmitted and received, and thus the portable electronic device will be disconnected.

### SUMMARY OF THE INVENTION

The present disclosure provides a dock that allows a portable electronic device to switch between antenna signal transceiving modes effectively without being affected by vibration accompanying vehicle movement or an external mechanism.

The present disclosure further provides a method of switching between antenna signals to allow a portable electronic device to switch between antenna signals effectively without being affected by vibration accompanying vehicle movement or an external mechanism.

The dock provided by the present disclosure is adapted to connect to a portable electronic device. The portable electronic device comprises a magnetic sensor. The portable electronic device has a first antenna signal transceiving mode and a second antenna signal transceiving mode. The portable electronic device switches from the first antenna signal transceiving mode to the second antenna signal transceiving mode when the magnetic sensor senses the presence of a magnetic force. The dock comprises a base, a back support element, a limit component and a magnetic component. The base has a connection surface. The back supporting element has a first end and an opposing second end. The first end adjoins the base. The limit component is disposed at the second end and faces the connection surface. The magnetic component is disposed on the connection surface and generates the magnetic force. The portable electronic device is adapted to be placed between the connection surface, the back supporting element and the limit component.

According to the present disclosure, a method of switching between antenna signals comprises the steps of: transmitting and receiving signals with an antenna of a portable electronic device; and sensing presence of a magnetic force at a dock with a magnetic sensor of the portable electronic device then transmitting and receiving signals with an antenna terminal of the dock if the magnetic force is present.

According to the present disclosure, a dock and a method of switching between antenna signals are advantageous in that joint use of a magnetic force of the magnetic component and a magnetic sensor enables the portable electronic device to switch between antenna signals efficiently by precluding vibration accompanying vehicle movement and external mechanism-induced antenna signal switching failures and errors.

To render them clearer and more comprehensible, the above and other objectives, features, and advantages of the present disclosure are hereunder illustrated with embodiments, depicted by the accompanying drawings, and described in detail below.

### BRIEF DESCRIPTION OF THE DRAWINGS

FIG. 1 is a top perspective view of a dock according to an embodiment of the present disclosure;

FIG. 2 is a schematic front view of the dock;

FIG. 3 is a schematic rear view of the dock;

FIG. 4 is a schematic view of the dock, viewed from the right thereof;

FIG. 5 is a block diagram of a portable electronic device according to an embodiment of the present disclosure;

FIG. 6 is a flowchart of a method of switching between antenna signal transceiving modes by the portable electronic device of FIG. 5; and

FIG. 7 is a schematic view of the process flow of the method of switching between antenna signals according to an embodiment of the present disclosure.

### DETAILED DESCRIPTION OF THE EMBODIMENTS

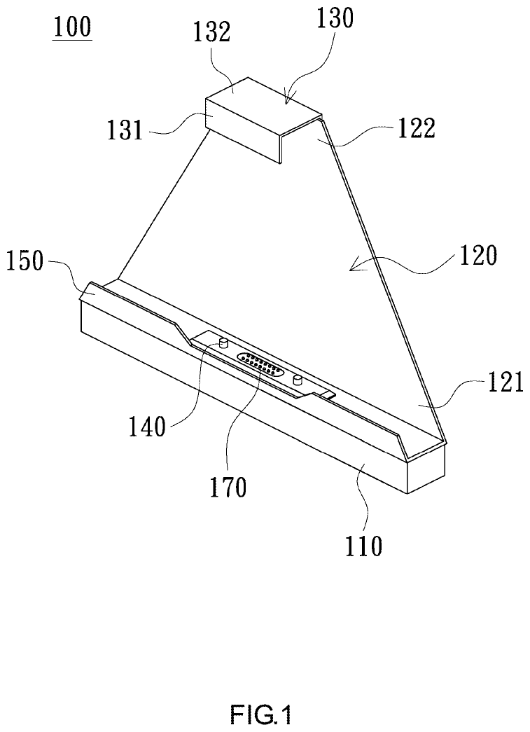

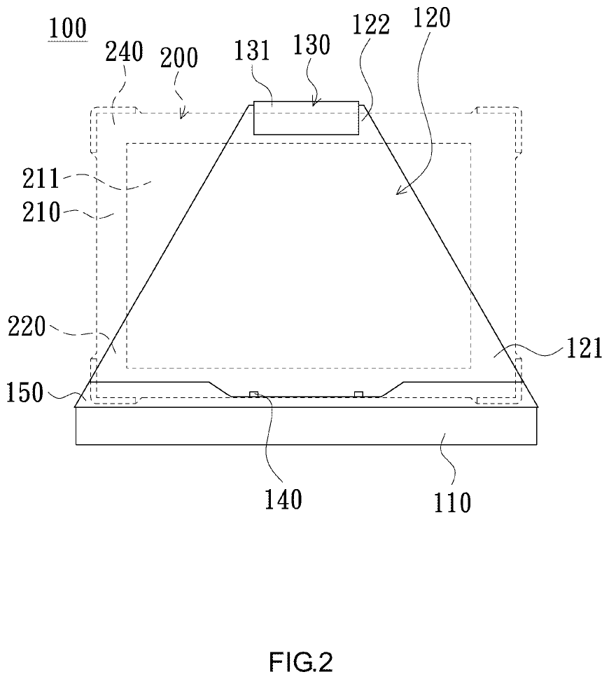

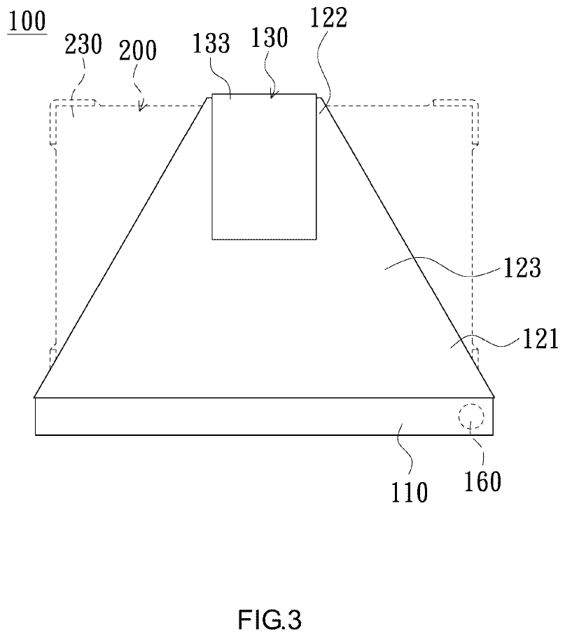

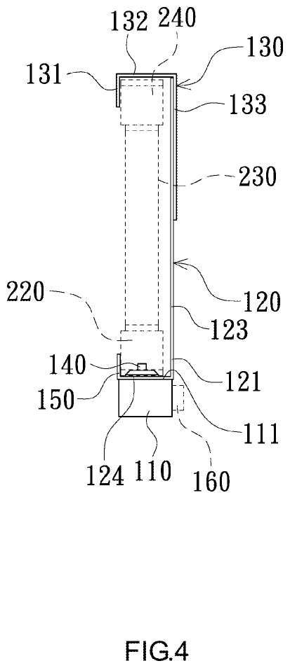

FIG. 1 is a top perspective view of a dock according to an embodiment of the present disclosure. FIG. 2 is a schematic front view of the dock. FIG. 3 is a schematic rear view of the dock. FIG. 4 is a schematic view of the dock, viewed from the right thereof. Referring to FIGS. 1-4, in this embodiment, a dock 100 is adapted to connect to a portable electronic device 200. The dock 100 comprises a base 110, a back supporting element 120, a limit component 130 and a magnetic component 140. The base 110 has a connection surface 111. The back supporting element 120 has a first end 121 and an opposing second end 122. The first end 121 adjoins the base 110. The limit component 130 is disposed at the second end 122 and faces the connection surface 111. The magnetic component 140 is disposed on the connection surface 111 and generates a magnetic force. The portable electronic device 200 is placed between the connection surface 111, the back supporting element 120 and the limit component 130. As shown in FIG. 1, the portable electronic device 200 is a tablet, but the present disclosure is not limited thereto. The portable electronic device 200 is, for example, a mobile phone or a navigator. When the portable electronic device 200 connects to the dock 100, a bottom portion 220 of the portable electronic device 200 rests on the connection surface 111, whereas a rear side portion 230 of the portable electronic device 200 adjoins the back supporting element 120, and a top portion 240 of the portable electronic device 200 adjoins the limit component 130.

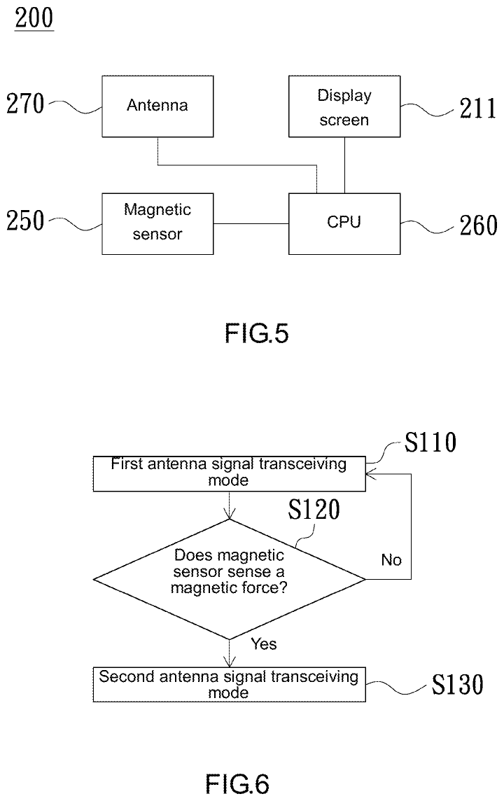

FIG. 5 is a block diagram of a portable electronic device according to an embodiment of the present disclosure. FIG. 6 is a flowchart of a method of switching between antenna signal transceiving modes by the portable electronic device of FIG. 5. Referring to FIGS. 2, 5 and 6, in this embodiment, a display screen 211 is disposed at a front side portion 210 of the portable electronic device 200. The portable electronic device 200 comprises a magnetic sensor 250 and has a first antenna signal transceiving mode and a second antenna signal transceiving mode. In this embodiment, the portable electronic device 200 is adapted to connect to the dock. In step S110, the portable electronic device 200 operates in the first antenna signal transceiving mode. In step S120, the magnetic sensor 250 senses for the presence of a magnetic force. If the magnetic sensor 250 senses a magnetic force which originates from the magnetic component 140 (the portable electronic device 200 connects to the dock 100), the portable electronic device 200 switches from the first antenna signal transceiving mode to the second antenna signal transceiving mode in step S130. If the magnetic sensor 250 does not sense any magnetic force which originates from the magnetic component 140, the portable electronic device 200 stays with the first antenna signal transceiving mode. The magnetic sensor 250 does not sense any magnetic force which originates from the magnetic component 140, because the portable electronic device 200 is not placed on the dock 100 illustrated in this embodiment; for instance, the portable electronic device 200 is not placed on any dock or is placed on a dock which lacks the magnetic component 140.

Referring to FIGS. 1 and 4, the magnetic component 140 protrudes from the connection surface 111, but the present invention is not limited thereto. For instance, the magnetic component 140 is disposed in the base 110 and positioned proximate to the connection surface 111. The magnetic component 140 comprises a permanent magnet or a non-permanent magnet, but the present invention is not limited thereto.

Referring to FIGS. 1, 2 and 4, the dock 100 further comprises a front blocking portion 150. The front blocking portion 150 connects to the connection surface 111. The connection surface 111 is disposed between the front blocking portion 150 and the first end 121. A bottom receiving chamber is formed between the front blocking portion 150, the connection surface 111 and the first end 121. The bottom portion 220 of the portable electronic device 200 is disposed in the bottom receiving chamber of the dock 100 such that the portable electronic device 200 is firmly disposed on the dock 100.

Referring to FIGS. 3 and 4, the back supporting element 120 further comprises a back abutting portion 123 and a bottom abutting portion 124. The back abutting portion 123 is disposed between the limit component 130 and the base 110. The bottom abutting portion 124 is disposed on the connection surface 111 and connected between the front blocking portion 150 and the back abutting portion 123. The bottom receiving chamber is disposed between the bottom abutting portion 124, the back abutting portion 123 and the front blocking portion 150. The bottom portion 220 of the portable electronic device 200 is placed on the connection surface 111 through the bottom abutting portion 124. The rear side portion 230 of the portable electronic device 200 abuts against the back abutting portion 123. In this embodiment, the back supporting element 120 and the front blocking portion 150 are integrally formed, but the present disclosure is not limited thereto. In another embodiment, the back supporting element 120 and the front blocking portion 150 are independent of each other.

Referring to FIGS. 1-4, the limit component 130 comprises a front limit portion 131 and a top limit portion 132. The top limit portion 132 is disposed between the front limit portion 131 and the first end 121. A top receiving chamber is formed between the front limit portion 131, the top limit portion 132 and the first end 121. The top portion 240 of the portable electronic device 200 is disposed in the top receiving chamber and thus confined to between the limit component 130 and the first end 121; hence, the portable electronic device 200 is firmly connected to the dock 100. The limit component 130 further comprises a link portion 133. The link portion 133 adjoins the second end 122. The top limit portion 132 is connected between the link portion 133 and the front limit portion 131.

Referring to FIGS. 2, 5 and 6, the portable electronic device 200 comprises a central processing unit (CPU) 260. The central processing unit 260 is electrically connected to the display screen 211 and the magnetic sensor 250. The central processing unit 260 executes the first antenna signal transceiving mode. If the magnetic sensor 250 senses a magnetic force which originates from the magnetic component 140, the magnetic sensor 250 will send a magnetic force signal to the central processing unit 260. After receiving the magnetic force signal from the magnetic sensor 250, the central processing unit 260 switches from the first antenna signal transceiving mode to the second antenna signal transceiving mode. If the magnetic sensor 250 does not sense a magnetic force which originates from the magnetic component 140, the magnetic sensor 250 will not send any magnetic force signal to the central processing unit 260, and the central processing unit 260 will still execute the first antenna signal transceiving mode.

Referring to FIGS. 3, 5 and 6, the portable electronic device 200 further comprises an antenna 270, and the dock 100 further comprises an antenna terminal 160. The antenna terminal 160 is disposed on the base 110. The antenna 270 is electrically connected to the central processing unit 260. The antenna terminal 160 is electrically connected to the central processing unit 260 and connected to an external antenna. The external antenna is, for example, a vehicular antenna, but the present invention is not limited thereto. In the first antenna signal transceiving mode, the portable electronic device 200 transmits and receives signals with the antenna 270. In the second antenna signal transceiving mode, the portable electronic device 200 transmits and receives signals with the antenna terminal 160.

Referring to FIGS. 1 and 5, the dock 100 further comprises a connection terminal 170. The connection terminal 170 is disposed on the connection surface 111. The antenna terminal 160 is electrically connected to the connection terminal 170. As soon as the portable electronic device 200 connects to the dock 100, the central processing unit 260 is electrically connected to the connection terminal 170. In the second antenna signal transceiving mode, the portable electronic device 200 transmits and receives signals with the antenna terminal 160 through the connection terminal 170.

In this embodiment, under the magnetic force of the magnetic component 140 of the dock 100, the portable electronic device 200 can effectively confirm whether to switch between the antenna signal transceiving modes but does not rely upon another external mechanism, such as the spring connector, to determine whether to switch between the antenna signal transceiving modes; hence, this embodiment precludes antenna signal transceiving mode switching failures and errors which might otherwise arise from improper operation or defects of the external mechanism. Moreover, the magnetic force has a longer reach than the external mechanism in terms of physical locations and ranges of operation; hence, even through the portable electronic device 200 may shift relative to the dock 100 because of vibration accompanying vehicle movement, the sensing for the magnetic force remains unaffected, and antenna signal transceiving mode switching failures and errors are still precluded.

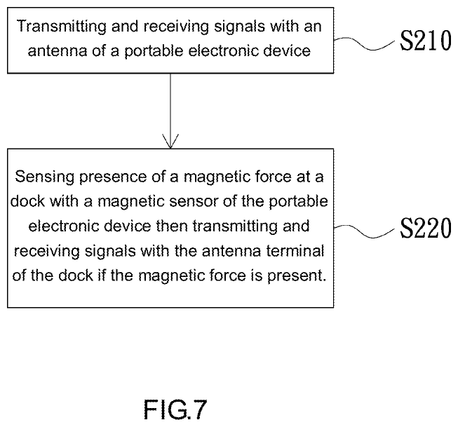

FIG. 7 is a schematic view of the process flow of the method of switching between antenna signals according to an embodiment of the present disclosure. Referring to FIG. 7, in this embodiment, the method of switching between antenna signals comprises step S210 and step S220. Step S210 involves transmitting and receiving signals with an antenna of a portable electronic device. Step S220 involves sensing presence of a magnetic force at a dock with a magnetic sensor of the portable electronic device then transmitting and receiving signals with the antenna terminal 160 of the dock if the magnetic force is present. Referring to FIGS. 1, 3 and 5-7, in this embodiment, the method of switching between antenna signals is applicable to the dock 100 and the portable electronic device 200. In step S210, the central processing unit 260 of the portable electronic device 200 executes the first antenna signal transceiving mode, so as to transmit and receive signals with the antenna 270. In step S220, the magnetic sensor 250 of the portable electronic device 200 senses presence of a magnetic force at a target dock (at this point in time, the portable electronic device 200 is placed on the target dock,) the central processing unit 260 of the portable electronic device 200 switches from the first antenna signal transceiving mode to the second antenna signal transceiving mode such that the portable electronic device 200 transmits and receives signals with the antenna terminal 160 of the dock 100 whenever the magnetic sensor 250 senses the magnetic force at the target dock (which indicates that the target dock is the dock 100.) If the magnetic sensor 250 does not sense presence of a magnetic force at the target dock, the portable electronic device 200 will stay with the first antenna signal transceiving mode. In this embodiment, the method of switching between antenna signals is exemplified by the dock 100 of FIG. 1 and the portable electronic device 200 of FIG. 5, but the present invention is not limited thereto.

In this embodiment, the method of switching between antenna signals precludes antenna signal transceiving mode switching failures and errors which might otherwise arise from improper operation or defects of the external mechanism and vibration accompanying vehicle movement, because the method relies upon the magnetic sensor 250 and the magnetic force when determining whether to switch between the antenna signals.

In conclusion, according to the present disclosure, a dock and a method of switching between antenna signals are advantageous in that joint use of a magnetic force of the magnetic component and a magnetic sensor enables the portable electronic device to switch between antenna signal transceiving modes efficiently by precluding vibration accompanying vehicle movement and external mechanism-induced antenna signal switching failures and errors.

Although the present disclosure is disclosed above by embodiments, the embodiments are not restrictive of the present disclosure. Any persons skilled in the art can make some changes and modifications to the embodiments without departing from the spirit and scope of the present disclosure. Accordingly, the legal protection for the present disclosure should be defined by the appended claims.

1. A dock, configured to be used in association with a vehicle having a vehicular antenna and is adapted to connect to a portable electronic device, the portable electronic device comprising a magnetic sensor and a device antenna and having a first antenna signal transceiving mode and a second antenna signal transceiving mode, the dock comprising:
a base having a connection surface;
a back supporting element having a first end and a second end opposing the first end, the first end adjoining the base;
a limit component disposed at the second end and facing the connection surface;
a magnetic component disposed on the connection surface and generating the magnetic force; and
an antenna terminal in communication with the vehicular antenna;
wherein the portable electronic device is adapted to be placed between the connection surface, the back supporting element and the limit component;
wherein when the magnetic sensor senses presence of a magnetic force, the portable electronic device switches from the first antenna signal transceiving mode in which the portable electronic device receives a signal from the device antenna, to the second antenna signal transceiving mode in which the portable electronic device receives a signal from the vehicular antenna via the antenna terminal.

2. The dock of claim 1, wherein the magnetic component comprises a permanent magnet or a non-permanent magnet.

3. The dock of claim 1, wherein the magnetic component protrudes from the connection surface.

4. The dock of claim 1, wherein the portable electronic device further comprises an antenna, whereas the dock further comprises an antenna terminal disposed at the base, allowing the portable electronic device to transmit and receive signals with the antenna in the first antenna signal transceiving mode and with the antenna terminal in the second antenna signal transceiving mode.

5. The dock of claim 4, wherein the dock further comprises a connection terminal disposed on the connection surface and electrically connected to the antenna terminal such that the portable electronic device transmits and receives signals with the antenna terminal through the connection terminal in the second antenna signal transceiving mode.

6. The dock of claim 1, further comprising a front blocking portion connected to the connection surface, the connection surface being disposed between the front blocking portion and the first end, allowing a bottom receiving chamber to be formed between the front blocking portion, the connection surface and the first end.

7. The dock of claim 6, wherein the back supporting element comprises a back abutting portion and a bottom abutting portion, the back abutting portion being disposed between the limit component and the base, the bottom abutting portion being disposed on the connection surface and connected between the front blocking portion and the back abutting portion, allowing the bottom receiving chamber to be disposed between the bottom abutting portion, the back abutting portion and the front blocking portion.

8. The dock of claim 1, wherein the limit component comprises a front limit portion and a top limit portion, the top limit portion being disposed between the front limit portion and the second end, allowing a top receiving chamber to be formed between the front limit portion, the top limit portion and the second end.

9. The dock of claim 8, wherein the limit component further comprises a link portion adjoining the second end such that the top limit portion is connected between the link portion and the front limit portion.

10. A method of switching between vehicular signals and device signals, comprising the steps of:
transmitting and receiving the device signals with an antenna of a portable electronic device; and
sensing presence of a magnetic force at a dock with a magnetic sensor of the portable electronic device then transmitting and receiving the vehicular signals with an vehicular antenna via an antenna terminal of the dock if the magnetic force is present.
